(19) United States
(12) Patent Application Publication
(10) Pub. No.: US 2025/0126566 A1
(43) Pub. Date: Apr. 17, 2025

(54) INITIATING SMALL DATA TRANSMISSION BASED ON ONE OR MORE CONDITIONS SPECIFIC TO DEVICE TYPE

(71) Applicant: NOKIA TECHNOLOGIES OY, Espoo (FI)

(72) Inventors: Jussi-Pekka KOSKINEN, Oulu (FI); Samuli Heikki TURTINEN, Ii (FI)

(21) Appl. No.: 18/688,555

(22) PCT Filed: Aug. 17, 2022
(86) PCT No.: PCT/EP2022/072936

§ 371 Date: Mar. 1, 2024

(30) Foreign Application Priority Data
Sep. 2, 2021 (FI) 20215926

(51) Int. Cl. H04W 52/02; H04B 17/318; H04W 74/0833; H04W 76/20

(52) U.S. Cl. CPC H04W 52/0261; H04B 17/328; H04W 52/0245; H04W 74/0833; H04W 76/20

(57) ABSTRACT

Disclosed is a method comprising obtaining one or more first conditions for small data transmission, said one or more first conditions being specific to a first device type, wherein the one or more first conditions are different compared with one or more second conditions for small data transmission, said one or more second conditions being associated with a second device type different to the first device type; and initiating, if the one or more first conditions are fulfilled, a small data transmission procedure, while in a radio resource control inactive state or idle state.

### FIELD

The following exemplary embodiments relate to wireless communication.

### BACKGROUND

Wireless communication systems are under constant development. For example, devices may transmit or receive a small amount of data in an inactive state to reduce signaling overhead from connection establishment, and to minimize power consumption.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: obtain one or more first conditions for small data transmission, said one or more first conditions being specific to a first device type, wherein the one or more first conditions are different compared with one or more second conditions for small data transmission, said one or more second conditions being associated with a second device type different to the first device type; and initiate, if the one or more first conditions are fulfilled, a small data transmission procedure, while in a radio resource control inactive state or idle state.

According to another aspect, there is provided an apparatus comprising: means for obtaining one or more first conditions for small data transmission, said one or more first conditions being specific to a first device type, wherein the one or more first conditions are different compared with one or more second conditions for small data transmission, said one or more second conditions being associated with a second device type different to the first device type; and means for initiating, if the one or more first conditions are fulfilled, a small data transmission procedure, while in a radio resource control inactive state or idle state.

According to another aspect, there is provided a method comprising: obtaining one or more first conditions for small data transmission, said one or more first conditions being specific to a first device type, wherein the one or more first conditions are different compared with one or more second conditions for small data transmission, said one or more second conditions being associated with a second device type different to the first device type; and initiating, if the one or more first conditions are fulfilled, a small data transmission procedure, while in a radio resource control inactive state or idle state.

According to another aspect, there is provided a computer program comprising instructions for causing an apparatus to perform at least the following: obtaining one or more first conditions for small data transmission, said one or more first conditions being specific to a first device type, wherein the one or more first conditions are different compared with one or more second conditions for small data transmission, said one or more second conditions being associated with a second device type different to the first device type; and initiating, if the one or more first conditions are fulfilled, a small data transmission procedure, while in a radio resource control inactive state or idle state.

According to another aspect, there is provided a computer program product comprising program instructions which, when run on a computing apparatus, cause the computing apparatus to perform at least the following: obtaining one or more first conditions for small data transmission, said one or more first conditions being specific to a first device type, wherein the one or more first conditions are different compared with one or more second conditions for small data transmission, said one or more second conditions being associated with a second device type different to the first device type; and initiating, if the one or more first conditions are fulfilled, a small data transmission procedure, while in a radio resource control inactive state or idle state.

According to another aspect, there is provided a computer readable medium comprising program instructions for causing an apparatus to perform at least the following: obtaining one or more first conditions for small data transmission, said one or more first conditions being specific to a first device type, wherein the one or more first conditions are different compared with one or more second conditions for small data transmission, said one or more second conditions being associated with a second device type different to the first device type; and initiating, if the one or more first conditions are fulfilled, a small data transmission procedure, while in a radio resource control inactive state or idle state.

According to another aspect, there is provided a non-transitory computer readable medium comprising program instructions for causing an apparatus to perform at least the following: obtaining one or more first conditions for small data transmission, said one or more first conditions being specific to a first device type, wherein the one or more first conditions are different compared with one or more second conditions for small data transmission, said one or more second conditions being associated with a second device type different to the first device type; and initiating, if the one or more first conditions are fulfilled, a small data transmission procedure, while in a radio resource control inactive state or idle state.

According to another aspect, there is provided an apparatus comprising at least one processor, and at least one memory including computer program code, wherein the at least one memory and the computer program code are configured, with the at least one processor, to cause the apparatus to: transmit, at least to one or more first terminal devices of a first device type, an indication indicating one or more first conditions for small data transmission, wherein the first indication is specific to the first device type, and wherein the one or more first conditions are different compared with one or more second conditions for small data transmission, said one or more second conditions being associated with a second device type different to the first device type.

According to another aspect, there is provided an apparatus comprising means for: transmitting, at least to one or more first terminal devices of a first device type, an indication indicating one or more first conditions for small data transmission, wherein the first indication is specific to the first device type, and wherein the one or more first conditions are different compared with one or more second conditions for small data transmission, said one or more second conditions being associated with a second device type different to the first device type.

According to another aspect, there is provided a method comprising: transmitting, at least to one or more first terminal devices of a first device type, an indication indicating one or more first conditions for small data transmission, wherein the first indication is specific to the first device type, and wherein the one or more first conditions are different compared with one or more second conditions for small data transmission, said one or more second conditions being associated with a second device type different to the first device type.

According to another aspect, there is provided a computer program comprising instructions for causing an apparatus to perform at least the following: transmitting, at least to one or more first terminal devices of a first device type, an indication indicating one or more first conditions for small data transmission, wherein the first indication is specific to the first device type, and wherein the one or more first conditions are different compared with one or more second conditions for small data transmission, said one or more second conditions being associated with a second device type different to the first device type.

According to another aspect, there is provided a computer program product comprising program instructions which, when run on a computing apparatus, cause the computing apparatus to perform at least the following: transmitting, at least to one or more first terminal devices of a first device type, an indication indicating one or more first conditions for small data transmission, wherein the first indication is specific to the first device type, and wherein the one or more first conditions are different compared with one or more second conditions for small data transmission, said one or more second conditions being associated with a second device type different to the first device type.

According to another aspect, there is provided a computer readable medium comprising program instructions for causing an apparatus to perform at least the following: transmitting, at least to one or more first terminal devices of a first device type, an indication indicating one or more first conditions for small data transmission, wherein the first indication is specific to the first device type, and wherein the one or more first conditions are different compared with one or more second conditions for small data transmission, said one or more second conditions being associated with a second device type different to the first device type.

According to another aspect, there is provided a non-transitory computer readable medium comprising program instructions for causing an apparatus to perform at least the following: transmitting, at least to one or more first terminal devices of a first device type, an indication indicating one or more first conditions for small data transmission, wherein the first indication is specific to the first device type, and wherein the one or more first conditions are different compared with one or more second conditions for small data transmission, said one or more second conditions being associated with a second device type different to the first device type.

According to another aspect, there is provided a system comprising at least a terminal device of a first device type, and a network element of a wireless communication network. The network element is configured to: transmit, at least to the terminal device of the first device type, an indication indicating one or more first conditions for small data transmission, wherein the first indication is specific to the first device type, and wherein the one or more first conditions are different compared with one or more second conditions for small data transmission, said one or more second conditions being associated with a second device type different to the first device type. The terminal device of the first device type is configured to: receive the indication from the network element; and initiate, if the one or more first conditions are fulfilled, a small data transmission procedure, while in a radio resource control inactive state or idle state.

According to another aspect, there is provided a system comprising at least a terminal device of a first device type, and a network element of a wireless communication network. The network element comprises means for: transmitting, at least to the terminal device of the first device type, an indication indicating one or more first conditions for small data transmission, wherein the first indication is specific to the first device type, and wherein the one or more first conditions are different compared with one or more second conditions for small data transmission, said one or more second conditions being associated with a second device type different to the first device type. The terminal device of the first device type comprises means for: receiving the indication from the network element; and initiating, if the one or more first conditions are fulfilled, a small data transmission procedure, while in a radio resource control inactive state or idle state.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIGS. 2-3 illustrate signaling diagrams according to some exemplary embodiments;

FIGS. 4-7 illustrate flow charts according to some exemplary embodiments;

FIGS. 8-9 illustrate apparatuses according to some exemplary embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

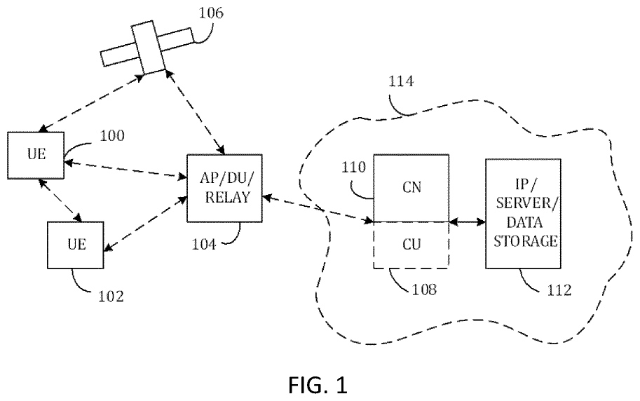

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB may be called uplink or reverse link and the physical link from the (e/g)NodeB to the user device may be called downlink or forward link. It should be appreciated that (e/g)NodeBs or their functionalities may be implemented by using any node, host, server or access point etc. entity suitable for such a usage.

A communication system may comprise more than one (e/g)NodeB, in which case the (e/g)NodeBs may also be configured to communicate with one another over links, wired or wireless, designed for the purpose. These links may be used for signaling purposes. The (e/g)NodeB may be a computing device configured to control the radio resources of communication system it is coupled to. The (e/g)NodeB may also be referred to as a base station, an access point or any other type of interfacing device including a relay station capable of operating in a wireless environment. The (e/g)NodeB may include or be coupled to transceivers. From the transceivers of the (e/g)NodeB, a connection may be provided to an antenna unit that establishes bi-directional radio links to user devices. The antenna unit may comprise a plurality of antennas or antenna elements. The (e/g)NodeB may further be connected to core network 110 (CN or next generation core NGC). Depending on the system, the counterpart on the CN side may be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and UE(s) and/or between the IAB node and other IAB nodes (multi-hop scenario).

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integrable with existing legacy radio access technologies, such as the LTE.

Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may also comprise other apparatuses, such as physical layer relay nodes or other network elements, etc. At least one of the (e/g)NodeBs or may be a Home (e/g)nodeB.

Furthermore, the (e/g)nodeB or base station may also be split into: a radio unit (RU) comprising a radio transceiver (TRX), i.e., a transmitter (TX) and a receiver (RX); one or more distributed units (DUs) that may be used for the so-called Layer 1 (L1) processing and real-time Layer 2 (L2) processing; and a central unit (CU) or a centralized unit that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the (e/g)nodeB or base station. The DU may be defined as a logical node hosting radio link control (RLC), medium access control (MAC) and/or physical (PHY) layers of the (e/g)nodeB or base station. The operation of the DU may be at least partly controlled by the CU. The CU may comprise a control plane (CU-CP), which may be defined as a logical node hosting the RRC and the control plane part of the PDCP protocol of the CU for the (e/g)nodeB or base station. The CU may further comprise a user plane (CU-UP), which may be defined as a logical node hosting the user plane part of the PDCP protocol and the SDAP protocol of the CU for the (e/g)nodeB or base station.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto-or picocells. The (e/g)NodeBs of FIG. 1 may provide any kind of these cells. A cellular radio system may be implemented as a multilayer network including several kinds of cells. In multilayer networks, one access node may provide one kind of a cell or cells, and thus a plurality of (e/g)NodeBs may be needed to provide such a network structure.

For fulfilling the need for improving the deployment and performance of communication systems, the concept of “plug-and-play” (e/g)NodeBs may be introduced. A network which may be able to use “plug-and-play” (e/g)NodeBs, may include, in addition to Home (e/g)NodeBs (H (e/g)nodeBs), a home node B gateway, or HNB-GW (not shown in FIG. 1). A HNB Gateway (HNB-GW), which may be installed within an operator's network, may aggregate traffic from a large number of HNBs back to a core network.

It is envisaged that a number of devices, such as sensors, actuators and similar devices for (massive) machine-type communications, or smartphones with chatting apps, that will generate (transmit) small amounts of data frequently or infrequently, will increase exponentially. (It should be appreciated that the above list is a non-limiting list of examples of apparatuses that may transmit small amounts of data.) In order to reduce signaling overhead from connection establishment and to minimize power consumption, in 5G and beyond, apparatuses may be enabled to transmit a small amount of data in an inactive state, using a process called small data transmission (SDT) procedure (small data transfer procedure). An apparatus in an inactive state may initiate the small data transmission procedure, if certain criteria are met, for example if the amount of uplink data to be transmitted is smaller than a data amount threshold. Data amount may also be referred to as data volume or data quantity. In other words, using 5G terminology, SDT is a procedure allowing data transmission while remaining in RRC_INACTIVE state (i.e., without transitioning to RRC_CONNECTED state). Thus, the SDT procedure may avoid the signaling overhead and delay associated with transitioning from RRC_INACTIVE state to RRC_CONNECTED state. SDT may be enabled on a radio bearer basis and initiated by the UE, if less than a configured amount of uplink (UL) data awaits transmission across the radio bearers for which SDT is enabled, measured reference signal received power (RSRP) in the cell is above a configured threshold, and a valid resource for SDT transmission is available.

RRC_INACTIVE is a state, wherein a UE remains in CM-CONNECTED state and can move within an area configured by the RAN without notifying the RAN. CM is an acronym for connection management. In the RRC_INACTIVE state, the last serving gNB keeps the UE context and the UE-associated connection with the serving access and mobility management function (AMF) and user plane function (UPF). The RRC_INACTIVE state may be used to reduce UE power consumption by alleviating the control plane (CP) procedures required at the RRC state change and associated latency. When a UE is in RRC_INACTIVE state, the radio connection is suspended, while the core network connectivity is maintained active (i.e., the UE remains in CM-CONNECTED state). A UE access stratum (AS) context (referred to as UE Inactive AS context) is stored at both the UE and RAN sides for quickly resuming a suspended connection, including the latest radio bearer configuration used for the data/signaling transmission, as well as the security keys and algorithms for integrity protection and ciphering in the radio interface. Based on this retained information, the UE can resume the radio connection with a much lower delay and associated signaling overhead, when compared to a UE in RRC_IDLE state that needs to establish a new connection to both the radio and core network.

The SDT procedure may take place on random-access channel (RACH) resources or type 1 configured grant (CG) resources. For CG, the SDT resources may be configured either on an initial bandwidth part (BWP) or on a dedicated BWP. For RACH, the network may also configure whether the 2-step and 4-step random-access types can be used. If both random-access types can be used, the UE may select one of the two random-access types.

Once initiated, an SDT procedure may last as long as the UE is not explicitly directed to RRC_IDLE or RRC_INACTIVE state (via RRCRelease), or to RRC_CONNECTED state (via RRCResume). After the initial SDT transmission, subsequent transmissions may be handled differently depending on the type of resources configured. When using CG resources, the network may schedule subsequent UL transmission using dynamic grants, or they may take place on the next CG resource occasions. When using RACH resources, the network may schedule subsequent UL and downlink (DL) transmissions using dynamic grants and assignments, respectively, after the completion of the random-access procedure.

A UE may perform a random-access procedure to access a network. The purpose of performing the random-access procedure may be, for example, initial access, handover, scheduling request, or timing synchronization. The random-access procedure may be a contention-based random-access procedure (CBRA) or a contention-free random-access procedure (CFRA). CFRA may also be referred to as non-contention based random access. In CFRA, a given UE has a dedicated (i.e., UE-specific) random-access preamble allocated by the network, whereas in CBRA the UE may select the preamble randomly from a pool of preambles shared with other UEs in the cell. CFRA is not currently supported for SDT over RACH. In CBRA, the contention (or collision) may occur, if two or more UEs attempt the random-access procedure by using the same random-access procedure on the same resource. In order to avoid the contention in CBRA, RACH preambles may be divided into two groups: group A and group B. Once the UE has selected the group to be used, the UE may select a preamble from the selected group to be transmitted to the network. Group A may be used for requesting a normal UL resource, when the amount of uplink data to be transmitted is small, and/or when the UE is in poor coverage (e.g., RSRP is low). Group B may be used for requesting a larger resource, when the amount of uplink data to be transmitted in Msg3 is larger, and the UE is in good coverage (e.g., RSRP is high).

5G is designed to address a wide range of use cases, such as the enhanced mobile broadband (eMBB), ultra-reliable low latency communication (URLLC), and massive machine-type communication (mMTC), with different requirements in terms of data rates, latency, reliability, coverage, energy efficiency, and connection density. mMTC may cover cellular low power wide area (LPWA) technologies such as narrowband internet of things (NB-IOT) and long term evolution for machine type communication (LTE-MTC). Yet another use case for 5G is time-sensitive communication (TSC). However, in between these use cases, there are also some other mid-range use cases, such as industrial wireless sensor networks, video surveillance, and wearables (e.g., smart watches, rings, eHealth-related devices, personal protection equipment, medical monitoring devices, etc.). In other words, the requirements of these mid-range use cases may be higher than LPWA, but lower than eMBB and URLLC. In order to efficiently serve these mid-range use cases, the 3rd generation partnership project (3GPP) has introduced the reduced capability (RedCap) devices in NR Release 17 (Rel-17). RedCap devices may also be referred to as RedCap UEs, NR-Lite devices, or NR-Light devices.

RedCap devices may have lower complexity (e.g., reduced bandwidth and number of antennas), a longer battery life, and a smaller form factor than high-end NR UEs, such as eMBB and URLLC devices. For example, a RedCap device may comprise 1 receiver branch and 1 transmitter branch (1Rx/1Tx), or 2 receiver branches and 1 transmitter branch (2Rx/1Tx), in both frequency range 1 (FR1) and frequency range 2 (FR2). RedCap devices may support all FR1 and FR2 bands for frequency-division duplexing (FDD) and time-division duplexing (TDD).

Industrial wireless sensors and actuators are one example of RedCap devices. It may be desirable to connect these sensors and actuators to 5G radio access and core networks in order to improve flexibility, enhance productivity and efficiency, and improve operational safety. Industrial wireless sensors may comprise, for example, pressure sensors, humidity sensors, thermometers, motion sensors, and/or accelerometers, etc. Industrial wireless sensor network use cases include not only URLLC services with very high requirements, but also relatively low-end services with the requirement of small device form factors, and/or being completely wireless with a battery life of several years. These low-end services may be provided by RedCap devices. Industrial wireless sensors associated with low-end services may also have the following use-case-specific requirements: communication service availability may be 99.99% and end-to-end latency may be less than 100 ms; and the reference bit rate may be less than 2 Mbps (potentially asymmetric, e.g., UL heavy traffic) for all use cases and the device is stationary. For safety-related sensors, the latency requirement may be lower, for example 5-10 ms.

Video surveillance cameras are another example of RedCap devices. The deployment of surveillance cameras may be beneficial, for example, for smart city use cases, as well as for factories and industries, in order to monitor and control city/factory resources more efficiently. Similar to connected industries, 5G connectivity may serve as catalyst for the next wave of smart city innovations. The following requirements may apply for video surveillance use cases: reference economic video bitrate may be 2-4 Mbps, latency less than 500 ms, and reliability 99%-99.9%. High-end video (e.g., for farming) may require a video bitrate of 7.5-25 Mbps. It is noted that traffic pattern may be dominated by UL transmissions.

Wearables, such as smart watches, rings, eHealth-related devices, personal protection equipment, and/or medical monitoring devices, are another example of RedCap devices. One characteristic for this use case is that the device is small in size. The following requirements may apply for wearables: reference bitrate for smart wearable application may be 5-50 Mbps in DL and 2-5 Mbps in UL, and the peak bit rate of the device may be higher, up to 150 Mbps for downlink and up to 50 Mbps for uplink. In addition, the battery of the wearable device should last multiple days (e.g., up to 1-2 weeks).

The maximum bandwidth of an FR1 RedCap device during and after initial access may be 20 MHz. The maximum bandwidth of an FR2 RedCap device during and after initial access may be 100 MHz.

For frequency bands, where a legacy NR UE is required to be equipped with a minimum of 2 Rx antenna ports, the minimum number of Rx branches supported for a RedCap device may be 1. The specification also supports 2 Rx branches for a RedCap device in these bands. Rx is an acronym for receiver.

For frequency bands, where a legacy NR UE (other than 2-Rx vehicular UE) is required to be equipped with a minimum of 4 Rx antenna ports, the minimum number of Rx branches supported for a RedCap device may be 1. The specification may also support 2 Rx branches for a RedCap device in these bands.

For a RedCap device with 1 Rx branch, 1 DL MIMO layer may be supported. For a RedCap device with 2 Rx branches, 2 DL MIMO layers may be supported. The gNB may know the number of Rx branches of the UE. Support of 256 QAM (quadrature amplitude modulation) in DL may be optional (instead of mandatory) for an FR1 RedCap device.

RedCap devices may be prevented from using capabilities such as carrier aggregation, dual connectivity, and wider bandwidths.

During a random-access procedure, a RedCap device may be explicitly identifiable to networks through an early indication in message 1 (Msg1, i.e., RACH preamble) and/or message 3 (Msg3), and message A (MsgA) if supported, including the ability for the early indication to be configurable by the network. Msg1 and Msg3 may be used in a 4-step random-access procedure, whereas MsgA may be used in a 2-step random-access procedure. In the 2-step random-access procedure, Msg1 and Msg3 may be combined into a single message (i.e., MsgA).

A system information indication may be used to indicate whether a RedCap device can camp on the cell/frequency or not. The indication may be specific to the number of Rx branches of the RedCap device.

RedCap devices may support extended discontinuous reception (eDRX) for RRC_INACTIVE and RRC_IDLE states with eDRX cycles up to 10.24 s, without using paging time window (PTW) and paging hyperframe (PH). There may be a common design (e.g., a common set of eDRX values) between RRC_INACTIVE and RRC_IDLE. Some RedCap devices may support eDRX for RRC_INACTIVE and RRC_IDLE states with eDRX cycles up to 10485.76 s. SDT may be used at least with an eDRX cycle less than or equal to 10.24 s.

There may be radio resource management (RRM) relaxations for neighbouring cells for RedCap devices for RRC_INACTIVE/RRC_IDLE and/or RRC_CONNECTED. Enabling and disabling of RRM relaxation may be under the network's control, and signalled by broadcasting or dedicated signaling.

It should be noted that RedCap devices may coexist with non-RedCap UEs (i.e., there may be both RedCap devices and non-RedCap UEs in a given cell).

However, the limited capabilities (e.g., reduced number of antennas, reduced bandwidth support, etc.) of RedCap devices are not currently taken into account in the SDT procedure, and therefore the SDT procedure is currently suboptimal for RedCap devices. For instance, RedCap devices with a reduced number of antennas may be unable to transmit and/or receive with the required power for the SDT session to be successful, which may lead to constant failures and interference for other devices performing SDT. Therefore, there is a need to improve the SDT procedure for RedCap devices.

Some exemplary embodiments may enhance SDT resource selection and/or SDT allowance determination for devices such as RedCap devices. In some exemplary embodiments, SDT allowance determination and resource selection criteria for RedCap devices may be adjusted by taking into account the limited capabilities of the RedCap device.

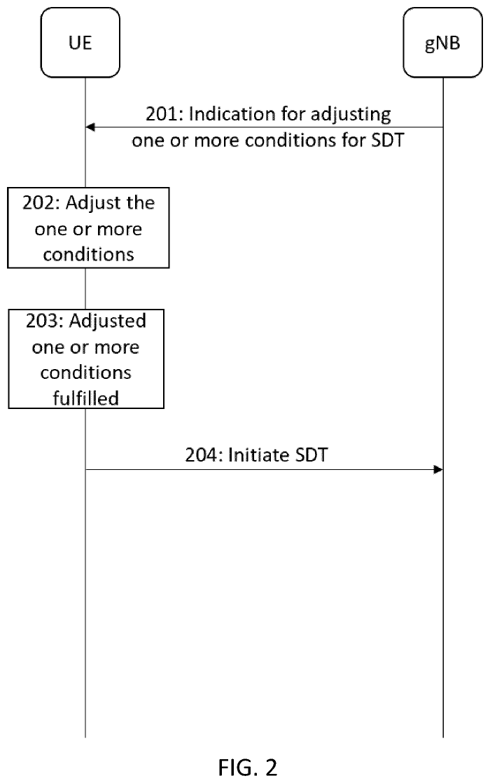

FIG. 2 illustrates a signaling diagram according to an exemplary embodiment, wherein the network explicitly indicates how RedCap devices should adjust the condition(s) for SDT. Referring to FIG. 2, a network element of a wireless communication network transmits 201, to one or more UEs, an indication for adjusting one or more conditions for SDT, wherein the indication is specific to RedCap devices (i.e., non-RedCap UEs may ignore the indication). The one or more UEs may comprise at least one RedCap device. The network element may be a base station such as a gNB.

The indication 201 may comprise at least one threshold value and/or a rule for adjusting the one or more conditions. The rule and the at least one threshold value may be specific to RedCap devices (i.e., non-RedCap UEs may not use them). Alternatively or additionally, the indication 201 may comprise at least an offset value for adjusting at least one of the one or more conditions.

The at least one threshold value may comprise at least one of: an uplink data amount threshold value for adjusting an uplink data amount condition for SDT allowance, an RSRP threshold value for adjusting an RSRP condition for SDT allowance, and/or a RACH preamble group (A or B) data amount threshold for resource selection, wherein these thresholds may be specific to RedCap devices.

The indication 201 may be transmitted to the at least one RedCap device by using dedicated signaling (i.e., by transmitting a device-specific indication to the at least one RedCap device).

Alternatively, the indidcation 201 may be broadcasted, for example via system information block (SIB) signaling, to a plurality of UEs (e.g., all UEs in the cell) comprising the at least one RedCap device and at least one non-RedCap UE. The broadcasting may cause a subset of the plurality of UEs to adjust the one or more conditions for SDT. For example, the subset of the plurality of UEs may comprise the at least one RedCap device, but non-RedCap UEs may not be included in the subset. In other words, the indication (comprising for example the at least one threshold value) may be broadcasted to both RedCap devices and to non-RedCap UEs, but only the RedCap devices may use the indication for adjusting the one or more conditions. Thus, only a certain type of device (e.g., RedCap devices) may be able to perform the adjustment of the SDT condition(s).

The at least one RedCap device adjusts 202 the one or more conditions based at least partly on the rule, the at least one threshold value, and/or the offset value received in the indication from the network element.

If the at least one RedCap device determines 203 that the adjusted one or more conditions are fulfilled, then the at least one RedCap device initiates 204 the SDT procedure and transmits a small data transmission to the network element.

The adjusted one or more conditions may also be referred to as one or more first conditions, and the original (unadjusted) one or more conditions may be referred to as one or more second conditions. In other words, the one or more first conditions may be obtained by adjusting the one or more second conditions.

It should be noted that some exemplary embodiments are not limited to RedCap devices, and the one or more conditions for SDT may also be adjusted by other types of devices/UEs.

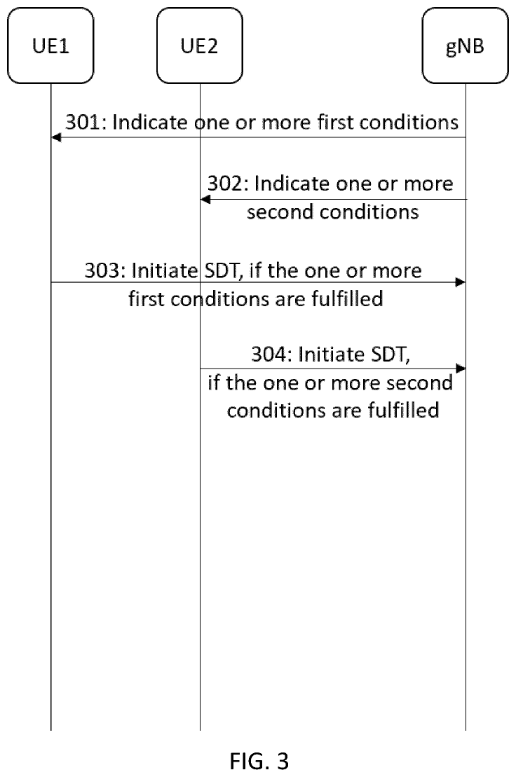

FIG. 3 illustrates a signaling diagram according to another exemplary embodiment, wherein the network signals different sets of conditions for SDT to different types of UEs. Referring to FIG. 3, a network element of a wireless communication network transmits 301, to one or more first UEs (denoted as UE1), a first indication indicating one or more first conditions for SDT. The network element transmits 302, to one or more second UEs (denoted as UE2), a second indication indicating one or more second conditions for SDT.

The one or more first conditions are specific to a first device type comprising the one or more first UEs. The one or more second conditions is associated with, or specific to, a second device type comprising the one or more second UEs. The one or more first conditions and the one or more second conditions are different, at least partly. For example, the one or more first conditions may comprise a first uplink data amount threshold and/or a first RSRP threshold for SDT allowance, and the one or more second conditions may comprise a second uplink data amount threshold and/or a second RSRP threshold for SDT allowance, wherein the value of the second uplink data amount threshold and/or the value of the second RSRP threshold may be different than the value of the first uplink data amount threshold and/or the value of the first RSRP threshold, respectively.

The first device type is different compared to the second device type. For example, the first device type may comprise, or refer to, RedCap devices, in which case the one or more first UEs may be RedCap device(s). The second device type may comprise, or refer to, non-RedCap UEs, in which case the one or more second UEs may be non-RedCap UE(s). The network element may be a base station such as a gNB.

As another example, the first device type may refer to 1Rx RedCap devices, in which case the one or more first UEs may be 1Rx RedCap device(s). In this case, the second device type may comprise, or refer to, 2Rx RedCap devices and/or non-RedCap UEs, in which case the one or more second UEs may comprise 2Rx RedCap device(s) and/or non-RedCap UEs. 1Rx RedCap device refers to a RedCap device that comprises a single receiver. 2Rx RedCap device refers to a RedCap device that comprises two receivers.

If the one or more first conditions are fulfilled at the one or more first UEs, then the one or more first UEs initiate 303 the SDT procedure and transmit a first small data transmission to the network element. If the one or more second conditions are fulfilled at the one or more second UEs, then the one or more second UEs initiate 304 the SDT procedure and transmit a second small data transmission to the network element.

It should be noted that some exemplary embodiments are not limited to RedCap devices, and the first device type may also be some other device type than RedCap device.

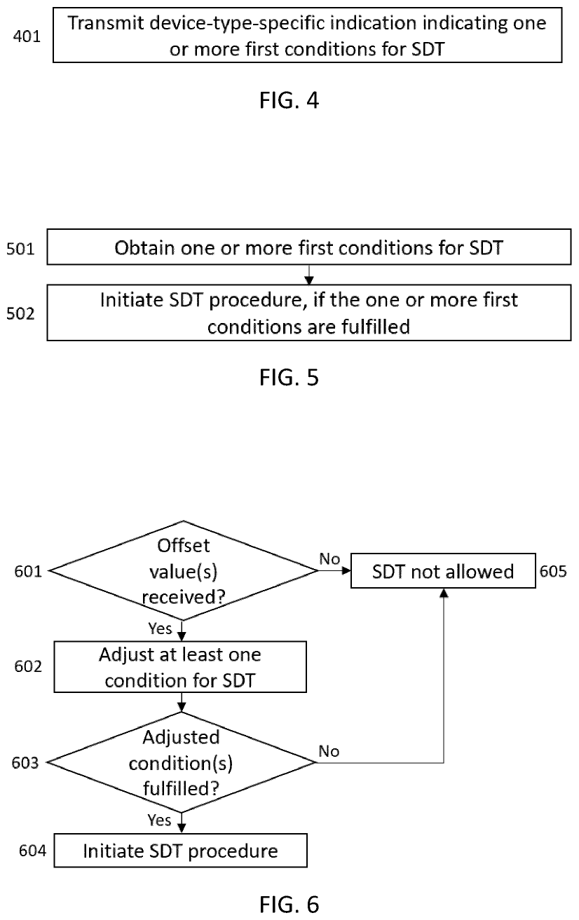

FIG. 4 illustrates a flow chart according to an exemplary embodiment. The functions illustrated in FIG. 4 may be performed by an apparatus such as, or comprised in, a network element such as a base station. Referring to FIG. 4, an indication indicating one or more first conditions for SDT is transmitted 401 at least to one or more first UEs of a first device type, wherein the first indication is specific to the first device type. The one or more first conditions are different compared with one or more second conditions for small data transmission, said one or more second conditions being associated with a second device type different to the first device type.

The first device type may refer, for example, to RedCap devices, and the one or more first UEs may comprise one or more RedCap devices. The second device type may refer, for example, to non-RedCap UEs.

As another example, the first device type may refer to 1Rx RedCap devices, in which case the one or more first UEs may be 1Rx RedCap device(s). In this case, the second device type may comprise, or refer to, 2Rx RedCap devices and/or non-RedCap UEs, in which case the one or more second UEs may comprise 2Rx RedCap device(s) and/or non-RedCap UEs.

The indication 401 may comprise at least one threshold value that is specific to the first device type. The at least one threshold value may comprise at least one of: an uplink data amount threshold value, an RSRP threshold value, and/or a RACH preamble group data amount threshold value. Alternatively or additionally, the indication 401 may comprise at least an offset value for adjusting at least one of the one or more second conditions.

The indication 401 may be broadcasted to a plurality of UEs comprising at least the one or more first UEs and one or more second UEs of the second device type. The broadcasting may cause the one or more first UEs to obtain the one or more first conditions by adjusting the one or more second conditions based on the indication, for example by applying the indicated at least one threshold value and/or the offset value to the one or more second conditions. Alternatively, the indication 401 may be transmitted to the one or more first UEs by using dedicated signaling.

FIG. 5 illustrates a flow chart according to an exemplary embodiment for determining SDT allowance. The functions illustrated in FIG. 5 may be performed by an apparatus such as, or comprised in, a terminal device (UE) (e.g., a RedCap device). Referring to FIG. 5, one or more first conditions for SDT are obtained 501, said one or more first conditions being specific to a first device type. The one or more first conditions are different compared with one or more second conditions for SDT, said one or more second conditions being associated with a second device type different to the first device type. For example, the one or more first conditions may comprise a condition for uplink data amount and/or a condition for RSRP.

The first device type may refer, for example, to RedCap devices, and the one or more first UEs may comprise one or more RedCap devices. The second device type may refer, for example, to non-RedCap UEs.

As another example, the first device type may refer to 1Rx RedCap devices, in which case the one or more first UEs may be 1Rx RedCap device(s). In this case, the second device type may comprise, or refer to, 2Rx RedCap devices and/or non-RedCap UEs, in which case the one or more second UEs may comprise 2Rx RedCap device(s) and/or non-RedCap UEs.

The one or more first conditions may be obtained based at least partly on at least one of: the bandwidth available at the apparatus (bandwidth supported by the apparatus), the number of antennas comprised in the apparatus, the number of receivers comprised in the apparatus, and/or the battery life of the apparatus, thus taking into account the limitations of the first device type (e.g., RedCap device) compared to the second device type (e.g., non-RedCap devices).

The one or more first conditions and/or the one or more second conditions may be obtained, for example, from pre-defined 3GPP specifications. In other words, the one or more first conditions and/or the one or more second conditions may be pre-defined.

Alternatively, the one or more first conditions and/or the one or more second conditions may be obtained by receiving the one or more first conditions and/or the one or more second conditions from the network (e.g. via broadcasting or dedicated signaling from the network).

Alternatively, the one or more first conditions may be obtained by adjusting, for example by dividing, multiplying, adding, or subtracting, a currently configured value of the one or more second conditions. In this case, the one or more second conditions may refer to default condition(s) or existing conditions(s) that are configured, for example, for all UEs in the cell by pre-defined 3GPP specifications or by broadcasting from the network. Thus, the adjusting makes the one or more first conditions different compared to the one or more second conditions. The rule for adjusting the one or more second conditions may be pre-defined (e.g., statically specified in 3GPP specification), or it may be indicated from the network.

The condition for uplink data amount (comprised in the one or more first conditions) may be associated with an uplink data amount threshold for allowing the SDT procedure to be initiated. The condition for uplink data amount (of the one or more first conditions) may be obtained by adjusting the uplink data amount threshold associated with the one or more second conditions. For example, the uplink data amount threshold may be adjusted by decreasing the uplink data amount threshold. In other words, the uplink data amount threshold may be scaled down such that less data is allowed for the first device type (e.g., RedCap device) than for the second device type (e.g., non-RedCap UEs), because of the limitations (e.g., antenna and bandwidth limitation) of the RedCap device compared to non-RedCap UEs. The rule and/or the value used for adjusting the uplink data amount threshold may be pre-defined (e.g., statically specified in 3GPP specification), or they may be indicated from the network.

The condition for RSRP (comprised in the one or more first conditions) may be associated with an RSRP threshold for allowing the SDT procedure to be initiated. The condition for RSRP (of the one or more first conditions) may be obtained by adjusting the RSRP threshold associated with the one or more second conditions. For example, the RSRP threshold may be adjusted by increasing the RSRP threshold, such that the RSRP threshold for the first device type (e.g., RedCap device) is higher than for the second device type (e.g., non-RedCap UEs) for allowing the SDT procedure to be initiated. The rule and/or the value used for adjusting the RSRP threshold may be pre-defined (e.g., statically specified in 3GPP specification), or they may be indicated from the network.

If the one or more first conditions are fulfilled, a small data transmission procedure is initiated 502, while in a radio resource control inactive state (RRC_INACTIVE) or radio resource control idle state (RRC_IDLE).

The condition for uplink data amount (comprised in the one or more first conditions) may be fulfilled, if an uplink data amount value of the small data transmission procedure (i.e., the data volume to be transmitted by SDT) is below or equal to the adjusted uplink data amount threshold. On the other hand, if the uplink data amount value is above the (adjusted) uplink data amount threshold, then SDT may not be allowed for the RedCap device.

The condition for RSRP (comprised in the one or more first conditions) may be fulfilled, if an RSRP value measured by the apparatus is above or equal to the adjusted RSRP threshold. On the other hand, if the measured RSRP value is below the adjusted RSRP threshold, then SDT may not be allowed for the RedCap device. The RSRP value may be measured on a reference signal received from the network (e.g., base station) prior to initiating the SDT procedure.

In some exemplary embodiments, different adjustments may be done by 1Rx RedCap devices and 2Rx RedCap devices. For example, only a 1Rx RedCap device may perform the adjustment of the one or more conditions for SDT, and a 2Rx RedCap devices may utilize a configuration for non-RedCap devices. For example, if the network has measured the configuration such that it is applicable to 2Rx RedCap devices, then in this case 1Rx RedCap devices may need to adjust the one or more conditions for SDT. Thus, it may be possible to utilize features (such as the number of receivers) of different devices in configuring and determining the condition(s) for SDT. In other words, the condition(s) for SDT may be different for different device types. As described previously, one way to obtain the SDT condition(s) for a certain device type is to adjust the SDT condition(s) of a different device type. The adjusting may be performed according to predefined criterion or criteria, or according to a configuration received from the network, to name a few examples.

FIG. 6 illustrates a flow chart according to another exemplary embodiment. FIG. 6 illustrates a rule for adjusting one or more conditions for SDT allowance, and initiating the SDT procedure based on the adjusted one or more conditions. The functions illustrated in FIG. 6 may be performed by an apparatus such as, or comprised in, a terminal device of a first device type (e.g., RedCap device).

Referring to FIG. 6, if at least one offset value for adjusting at least one condition for SDT allowance is received (601: yes) from a network element of a wireless communication network (e.g., from a base station), then the at least one condition for SDT allowance is adjusted 602 by applying (e.g., adding or subtracting) the at least one offset value to the at least one condition. The at least one condition may comprise, for example, a condition for uplink data amount and/or a condition for RSRP. The offset value may be a positive or negative numerical value. As a non-limiting example, an offset value of +3 dB may be added to the RSRP threshold of the condition for RSRP in order to increase the RSRP threshold.

On the other hand, if no offset value for adjusting at least one condition for SDT is received (601: no), then SDT is not allowed 605. In other words, in case the network does not configure the adjustment and/or offset value(s) over dedicated or broadcast signaling for the apparatus (e.g., RedCap device), then SDT is not allowed for the apparatus. In one example, this restriction may only apply for 1Rx RedCap devices, but not for 2Rx RedCap devices.

If the adjusted at least one condition is fulfilled (603: yes), then the SDT procedure is initiated 604. For example, the adjusted at least one condition may be fulfilled, if the uplink data amount to be transmitted is below or equal to the adjusted uplink data amount threshold of the adjusted condition for uplink data amount, and/or if the measured RSRP value is above or equal to the adjusted RSRP threshold of the adjusted condition for RSRP.

On the other hand, if the adjusted at least one condition is not fulfilled (603: no), then SDT is not allowed 605.

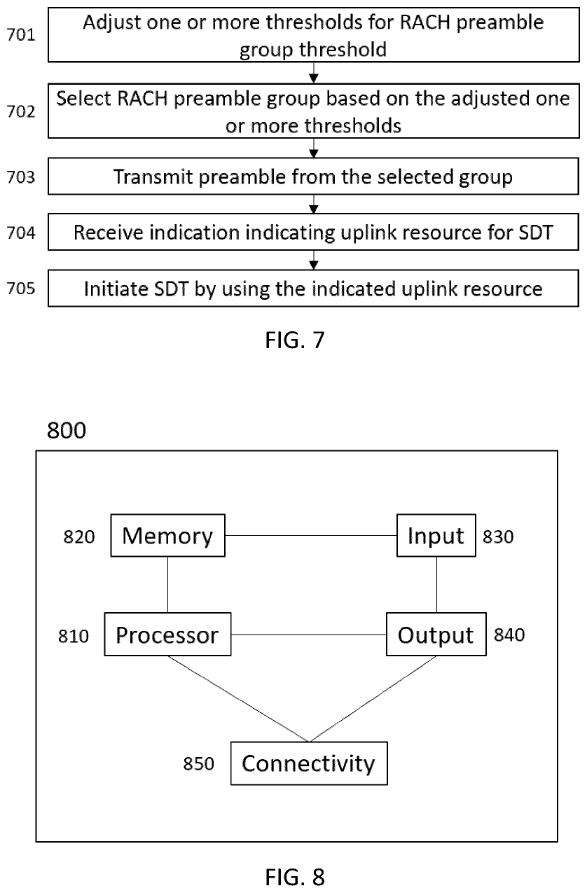

FIG. 7 illustrates a flow chart according to an exemplary embodiment for SDT resource determination. The functions illustrated in FIG. 7 may be performed by an apparatus such as, or comprised in, a terminal device of a first device type (e.g., RedCap device).

Referring to FIG. 7, one or more thresholds for selecting between RACH preamble groups are adjusted 701. For example, the apparatus (e.g. RedCap device) may increase or decrease a RACH preamble group data amount threshold and/or RSRP threshold to be higher or lower than for a second device type (e.g., non-RedCap UEs), such that the apparatus (e.g., RedCap device) is less likely (after increasing the thresholds) or more likely (after decreasing the thresholds) to select RACH preamble group B compared to the second device type (e.g., non-RedCap UEs).

A RACH preamble group is selected 702 based at least partly on the adjusted one or more thresholds. The selected RACH preamble group may be, for example, group A or group B. For example, group A may be selected when the uplink data amount to be transmitted is small, i.e., below or equal to the adjusted RACH preamble group data amount threshold, and/or or when the apparatus is in poor coverage (e.g., measured RSRP value is below the adjusted RSRP threshold). Group B may be selected when the uplink data amount to be transmitted is larger, i.e. above the adjusted RACH preamble group data amount threshold, and/or or when the apparatus is in good coverage (e.g., measured RSRP value is above or equal to the adjusted RSRP threshold).

Alternatively, the apparatus may not be allowed to select RACH preambles from group B.

A random-access preamble from the selected RACH preamble group is transmitted 703 to a network element of a wireless communication network for requesting an uplink resource for SDT. The uplink resource may comprise a time resource and/or a frequency resource.

An indication, for example an uplink grant comprised in a random-access response (i.e., Msg2), indicating the uplink resource for SDT is received 704 from the network element.

The SDT procedure is initiated 705 by using the indicated uplink resource. In other words, a small data transmission may be transmitted by using the indicated uplink resource.

The functions and/or blocks described above by means of FIGS. 2-7 are in no absolute chronological order, and some of them may be performed simultaneously or in an order differing from the described one. Other functions and/or blocks may also be executed between them or within them.

A technical advantage provided by some exemplary embodiments is that they may provide an improved SDT procedure that takes into account the limitations of the apparatus (e.g., RedCap device). Some exemplary embodiments may improve UL and DL SDT transmission for apparatuses such as RedCap devices, such that the SDT procedure is not attempted in poor radio conditions, and/or when there is too much data to be transmitted.

FIG. 8 illustrates an apparatus 800, which may be an apparatus such as, or comprised in, a terminal device of a first device type, according to an exemplary embodiment. The terminal device may also be referred to as a UE, user equipment, or a RedCap device herein. The apparatus 800 comprises a processor 810. The processor 810 interprets computer program instructions and processes data. The processor 810 may comprise one or more programmable processors. The processor 810 may comprise programmable hardware with embedded firmware and may, alternatively or additionally, comprise one or more application-specific integrated circuits (ASICs).

The processor 810 is coupled to a memory 820. The processor is configured to read and write data to and from the memory 820. The memory 820 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 820 stores computer readable instructions that are executed by the processor 810. For example, non-volatile memory stores the computer readable instructions and the processor 810 executes the instructions using volatile memory for temporary storage of data and/or instructions.

The computer readable instructions may have been pre-stored to the memory 820 or, alternatively or additionally, they may be received, by the apparatus, via an electromagnetic carrier signal and/or may be copied from a physical entity such as a computer program product. Execution of the computer readable instructions causes the apparatus 800 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 800 may further comprise, or be connected to, an input unit 830. The input unit 830 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 830 may comprise an interface to which external devices may connect to.

The apparatus 800 may also comprise an output unit 840. The output unit may comprise or be connected to one or more displays capable of rendering visual content, such as a light emitting diode (LED) display, a liquid crystal display (LCD) and/or a liquid crystal on silicon (LCoS) display. The output unit 840 may further comprise one or more audio outputs. The one or more audio outputs may be for example loudspeakers.

The apparatus 800 further comprises a connectivity unit 850. The connectivity unit 850 enables wireless connectivity to one or more external devices. The connectivity unit 850 comprises at least one transmitter and at least one receiver that may be integrated to the apparatus 800 or that the apparatus 800 may be connected to. The at least one transmitter comprises at least one transmission antenna, and the at least one receiver comprises at least one receiving antenna. The connectivity unit 850 may comprise an integrated circuit or a set of integrated circuits that provide the wireless communication capability for the apparatus 800. Alternatively, the wireless connectivity may be a hardwired application-specific integrated circuit (ASIC). The connectivity unit 850 may comprise one or more components such as a power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 800 may further comprise various components not illustrated in FIG. 8. The various components may be hardware components and/or software components.

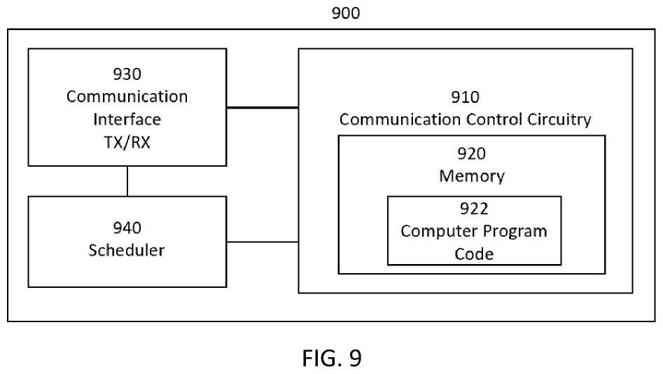

The apparatus 900 of FIG. 9 illustrates an exemplary embodiment of an apparatus such as, or comprised in, a base station. The base station may be referred to, for example, as a network element, a RAN node, a NodeB, an LTE evolved NodeB (eNB), a gNB, an NR base station, a 5G base station, an access node, an access point (AP), a distributed unit (DU), a central unit (CU), a baseband unit (BBU), a radio unit (RU), a radio head, a remote radio head (RRH), or a transmission and reception point (TRP). The apparatus may comprise, for example, a circuitry or a chipset applicable to a base station for realizing some of the described exemplary embodiments. The apparatus 900 may be an electronic device comprising one or more electronic circuitries. The apparatus 900 may comprise a communication control circuitry 910 such as at least one processor, and at least one memory 920 including a computer program code (software) 922 wherein the at least one memory and the computer program code (software) 922 are configured, with the at least one processor, to cause the apparatus 900 to carry out some of the exemplary embodiments described above.

The processor is coupled to the memory 920. The processor is configured to read and write data to and from the memory 920. The memory 920 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 920 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 920 or, alternatively or additionally, they may be received, by the apparatus, via an electromagnetic carrier signal and/or may be copied from a physical entity such as a computer program product. Execution of the computer readable instructions causes the apparatus 900 to perform one or more of the functionalities described above.

The memory 920 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some exemplary embodiments, structures of the frames used in the detected neighbour cells.

The apparatus 900 may further comprise a communication interface 930 comprising hardware and/or software for realizing communication connectivity according to one or more communication protocols. The communication interface 930 comprises at least one transmitter (TX) and at least one receiver (RX) that may be integrated to the apparatus 900 or that the apparatus 900 may be connected to. The communication interface 930 provides the apparatus with radio communication capabilities to communicate in the cellular communication system. The communication interface may, for example, provide a radio interface to terminal devices. The apparatus 900 may further comprise another interface towards a core network such as the network coordinator apparatus and/or to the access nodes of the cellular communication system. The apparatus 900 may further comprise a scheduler 940 that is configured to allocate resources.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s)), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1. An apparatus comprising at least one processor, and at least one memory including computer program code, wherein the at least one memory and the computer program code are configured, with the at least one processor, to cause the apparatus to:
obtain one or more first conditions for small data transmission, said one or more first conditions being specific to a first device type, wherein the one or more first conditions are different compared with one or more second conditions for small data transmission, said one or more second conditions being associated with a second device type different to the first device type; and
initiate, if the one or more first conditions are fulfilled, a small data transmission procedure, while in a radio resource control inactive state or idle state.

2. An apparatus according to claim 1, wherein the one or more first conditions comprise at least a condition for uplink data amount;
wherein the apparatus is further caused to:
obtain the condition for uplink data amount by adjusting an uplink data amount threshold for small data transmission, said uplink data amount threshold being comprised in the one or more second conditions;
wherein the condition for uplink data amount is fulfilled, if an uplink data amount value of the small data transmission procedure is below or equal to the adjusted uplink data amount threshold.

3. An apparatus according to claim 2, wherein the uplink data amount threshold is adjusted by decreasing the uplink data amount threshold.

4. An apparatus according to claim 1, wherein the one or more first conditions comprise at least a condition for reference signal received power;
wherein the apparatus is further caused to:
obtain the condition for reference signal received power by adjusting a reference signal received power threshold for small data transmission, said reference signal received power threshold being comprised in the one or more second conditions;
wherein the condition for reference signal received power is fulfilled, if a measured reference signal received power value is above or equal to the adjusted reference signal received power threshold.

5. An apparatus according to claim 4, wherein the reference signal received power threshold is adjusted by increasing the reference signal received power threshold.

6. An apparatus according to claim 1, wherein the apparatus is further caused to:
adjust a random-access channel preamble group data amount threshold;
select a random-access channel preamble group based at least partly on the adjusted random-access channel preamble group data amount threshold;
transmit a random-access preamble from the selected random-access channel preamble group for requesting an uplink resource for the small data transmission procedure; and
receive an indication indicating the uplink resource for the small data transmission procedure;
wherein the small data transmission procedure is initiated by using the indicated uplink resource.

7. An apparatus according to claim 1, wherein the one or more first conditions are obtained by dividing, multiplying, adding, or subtracting a configured value of at least one condition of the one or more second conditions.

8. An apparatus according to claim 1, wherein the apparatus is further caused to:
receive at least one offset value for adjusting at least one condition of the one or more second conditions; and
obtain the one or more first conditions by applying the at least one offset value to the at least one condition of the one or more second conditions;
wherein the small data transmission procedure is initiated, if the at least one offset value is received and the one or more first conditions are fulfilled.

9. An apparatus according to claim 1, wherein the one or more first conditions are obtained based at least partly on at least one of: a bandwidth, a number of antennas, a number of receivers, a battery life of the apparatus.

10. An apparatus according to claim 1, wherein the apparatus is further caused to:
obtain the one or more first conditions and/or the one or more second conditions by receiving the one or more first conditions and/or the one or more second conditions from a network element of a wireless communication network.

11. An apparatus according to claim 1, wherein the first device type refers to reduced capability devices, and the apparatus is or is comprised in a reduced capability device.

12.-17. (canceled)

18. A method comprising:
obtaining one or more first conditions for small data transmission, said one or more first conditions being specific to a first device type, wherein the one or more first conditions are different compared with one or more second conditions for small data transmission, said one or more second conditions being associated with a second device type different to the first device type; and
initiating, if the one or more first conditions are fulfilled, a small data transmission procedure, while in a radio resource control inactive state or idle state.

19. (canceled)

20. A non-transitory computer-readable medium comprising instructions for causing an apparatus to perform at least the following:
obtaining one or more first conditions for small data transmission, said one or more first conditions being specific to a first device type, wherein the one or more first conditions are different compared with one or more second conditions for small data transmission, said one or more second conditions being associated with a second device type different to the first device type; and
initiating, if the one or more first conditions are fulfilled, a small data transmission procedure, while in a radio resource control inactive state or idle state.

21. (canceled)

22. A system comprising at least a terminal device of a first device type, and a network element of a wireless communication network;
wherein the network element is configured to:
transmit, at least to the terminal device of the first device type, an indication indicating one or more first conditions for small data transmission, wherein the first indication is specific to the first device type, and wherein the one or more first conditions are different compared with one or more second conditions for small data transmission, said one or more second conditions being associated with a second device type different to the first device type;
wherein the terminal device is configured to:
receive the indication from the network element; and
initiate, if the one or more first conditions are fulfilled, a small data transmission procedure, while in a radio resource control inactive state or idle state.
